(19) United States
(12) Patent Application Publication
(10) Pub. No.: US 2013/0152900 A1
(43) Pub. Date: Jun. 20, 2013

(54) INTERNAL COMBUSTION ENGINE

(71) Applicant: Masahiko Masubuchi, Mishima-shi (JP)

(72) Inventor: Masahiko Masubuchi, Mishima-shi (JP)

(73) Assignee: TOYOTA JIDOSHA KABUSHIKI KAISHA, Toyota-shi, Aichi-ken (JP)

(21) Appl. No.: 13/819,926

(22) PCT Filed: Sep. 1, 2011
(86) PCT No.: PCT/IB2011/002012

§ 371 Date: Feb. 28, 2013

(30) Foreign Application Priority Data
Sep. 3, 2010 (JP) 2010-198308

(51) Int. Cl. F02M 39/00

(52) U.S. Cl. CPC F02M 39/00
USPC 123/445

(57) ABSTRACT

An internal combustion engine (100) includes: a first fuel supply portion (28) which is provided in a combustion chamber (12) or in an intake passageway (40) that communicates with the combustion chamber (12), and which supplies a first fuel; a second fuel supply portion (24) that is provided in the combustion chamber (12) and that supplies a second fuel that is capable of compression-ignited fuel; and a third fuel to supply portion (26) that is provided in the intake passageway (40) and that supplies the second fuel.

### BACKGROUND OF THE INVENTION

1. Field of the Invention

The invention relates to an internal combustion engine capable of simultaneously using a plurality of fuels.

2. Description of Related Art

Among the internal combustion engines capable of using a plurality of fuels, there is known an internal combustion engine that improves the thermal efficiency and the like by mixing a plurality of fuels and burning the mixture thereof (multi-fuel combustion). For example, Japanese Patent Application Publication No. 2003-532828 (JP-A-2003-532828) discloses an internal combustion engine in which a premixed charge compression ignition is performed by injecting natural gas from an injection valve (injector) that is provided in a port, and by injecting diesel fuel from an injector that is provided in a cylinder (in a combustion chamber).

Since the foregoing internal combustion engine is provided with only one injector for injecting natural gas and only one injector for injecting diesel fuel, it sometimes happens that efficient operation of the engine fails to be performed depending on the operation region. Therefore, deteriorated fuel economy or increased emissions sometimes result.

### SUMMARY OF THE INVENTION

The invention provides an internal combustion engine capable of efficiently operating in a broader operation region than conventional engines.

An aspect of the invention relates to an internal combustion engine. This internal combustion engine includes: a first fuel supply portion which is provided in a combustion chamber or in an intake passageway that communicates with the combustion chamber, and which supplies a first fuel; a second fuel supply portion that is provided in the combustion chamber and that supplies a second fuel that is capable of compression-ignited fuel; and a third fuel supply portion that is provided in the intake passageway and that supplies the second fuel.

The foregoing internal combustion engine may further include a control portion that controls the first fuel supply portion, the second fuel supply portion and the third fuel supply portion, and the control portion may be capable of switching between an operation mode in which the first fuel and the second fuel are supplied into the combustion chamber by using the first fuel supply portion and one of the second fuel supply portion and the third fuel supply portion, and an operation mode in which the second fuel is supplied into the combustion chamber by using the second fuel supply portion.

During an idle operation, the control portion may supply the second fuel into the combustion chamber by using the second fuel supply portion.

When load during operation is smaller than a threshold value determined based on an operation condition and the operation presently occurring is not an idle operation, the control portion may supply the first fuel and the second fuel into the combustion chamber by using the first fuel supply portion and the third fuel supply portion.

When load during operation is larger than a threshold value determined based on an operation condition, the control portion may supply the first fuel and the second fuel into the combustion chamber by using the first fuel supply portion and the second fuel supply portion.

The first fuel supply portion may be provided in the intake passageway, and a supply opening of the first fuel supply portion and a supply opening of the third fuel supply portion may be disposed so that the first fuel supplied from the first fuel supply portion and the second fuel supplied from the third fuel supply portion intersect and collide with each other.

The first fuel supply portion may be provided in the intake passageway, and may be disposed so that the first fuel collides with the second fuel from the third fuel supply portion, in a downstream portion of the intake passageway which is downstream of the third fuel supply portion.

The first fuel may be natural gas, and the second fuel may be light oil.

According to the internal combustion engine in accordance with the foregoing aspect of the invention, it is possible to perform efficient operation in a broader operation region than in the related art.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing an overall construction of an internal combustion engine in accordance with a first embodiment of the invention;

FIG. 2 is a diagram showing details of the construction of the internal combustion engine in accordance with the first embodiment;

FIG. 3 is a map that shows a relationship between operation conditions and an injection switching control;

FIGS. 4A to 4C are diagrams (Illustration 1 of 2) showing modifications of the first embodiment;

FIG. 5 is a diagram (Illustration 2 of 2) showing a further modification of the first embodiment;

FIG. 6 is a diagram showing an overall construction of an internal combustion engine in accordance with a second embodiment of the invention; and

FIG. 7 is a diagram showing details of the construction of the internal combustion engine in accordance with the second embodiment.

### DETAILED DESCRIPTION OF EMBODIMENTS

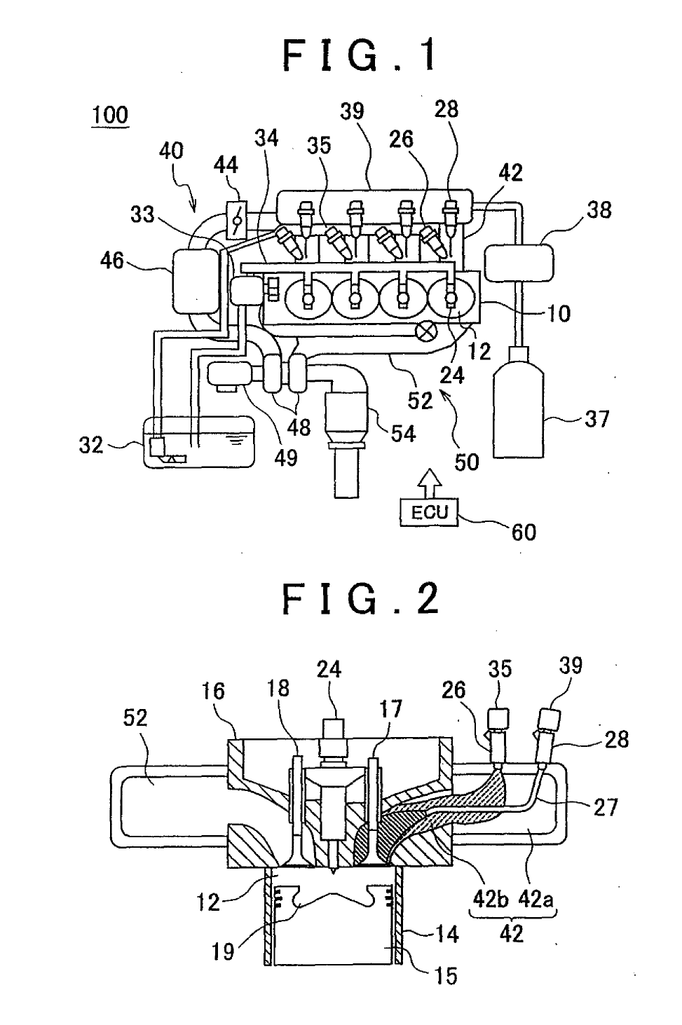

FIG. 1 is a diagram showing an overall construction of an internal combustion engine in accordance with a first embodiment of the invention. An internal combustion engine 100 is a dual-fuel internal combustion engine capable of combustion of a mixture of CNG (compressed natural gas) as a main fuel and light oil as a subsidiary fuel, and has an engine block 10 of, for example, an in-line four-cylinder arrangement. A light-oil in-cylinder injector 24 is provided in each of combustion chambers 12 of the engine block 10. The light-oil in-cylinder injectors 24 are supplied with light-oil fuel from a light-oil fuel tank 32 via a high-pressure pump 33 and a common rail 34.

Each of intake ports 42 that communicate with the corresponding combustion chambers 12 is provided with a light-oil port injector 26 and a CNG port injector 28. The light-oil port injectors 26 are supplied with light-oil fuel from the light-oil fuel tank 32 via a light-oil fuel delivery pipe 35. The CNG port injectors 28 are supplied with CNG fuel from a CNG fuel tank 37 via a regulator 38 and a CNG delivery pipe 39.

An intake passageway 40 of the engine block 10 is provided with the intake ports 42, a throttle valve 44 for flow adjustment, an intercooler 46, a turbocharger 48 and an air cleaner 49 in that order from the downstream side. An exhaust passageway 50 of the engine block 10 is provided with exhaust ports 52, the turbocharger 48, and a start converter 54 that contains a catalyst for exhaust gas control, in that order from the upstream side.

Besides, the internal combustion engine 100 is equipped with an ECU (engine control unit) as a control portion. The ECU 60 acquires information regarding operation conditions of the internal combustion engine 100 (e.g., the operation load and the engine rotation speed thereof) on the basis of outputs of sensors and the like (not shown) which indicate the degree of opening of the throttle valve 44, the engine rotation speed, etc. Besides, on the basis of the acquired operation conditions, the ECU 60 performs fuel injection controls of the light-oil in-cylinder injectors 24, the light-oil port injectors 26 and the CNG port injectors 28.

FIG. 2 is a diagram showing details of the construction of a combustion chamber 12 and its vicinity. Each combustion chamber 12 is defined by a cylinder 14, a piston 15 and a cylinder head 16. The light-oil in-cylinder injectors 24 are provided over the combustion chambers 12. An intake side of each combustion chamber 12 communicates with a corresponding one of the intake ports 42 via an intake valve 17. An upstream portion 42a of each intake port 42 constitutes a space that is used for all the combustion chambers 12. A downstream portion 42b of each intake port 42 is a passageway that is provided for a corresponding one of the combustion chambers 12 formed in the engine block 10. An exhaust side of each combustion chamber 12 communicates with a corresponding one of the exhaust ports 52 via an exhaust valve 18.

The light-oil port injectors 26 and the CNG port injectors 28 are provided in the upstream portion 42a of the intake ports 42. Each light-oil port injector 26 injects light-oil fuel into the upstream portion 42a of the intake ports 42. Each CNG port injector 28 injects CNG fuel into the downstream portion 42b of a corresponding one of the intake ports 42 through a metal pipe 27.

Light oil, which ignites when sufficiently compressed, burns when compressed in the combustion chambers 12. On the other hand, CNG does not ignite under compression. Therefore, a mixture of CNG fuel and light-oil fuel is formed beforehand, and then light-oil fuel is burned as a kindler (this combustion is termed multi-fuel combustion). Which one of the two fuels is to be used can be determined (or selected) in accordance with the operation condition of the internal combustion engine 100. Hereinafter, this will be described in detail.

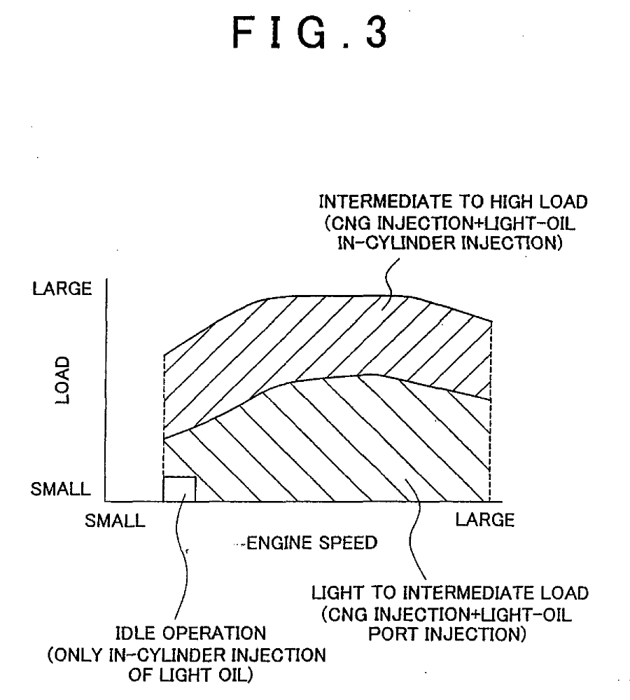

FIG. 3 is a map showing a relationship between the operation condition of the internal combustion engine 100 and the injection switch control. The horizontal axis of the map shows the engine rotation speed, and the vertical axis of the map shows the load that occurs during operation of the engine. During an idle operation shown in a lower left region in the map, the amount of fuel that is burned is small, so that if the multi-fuel combustion of CNG and light oil is conducted, the absolute amount of light oil that is burned becomes insufficient, resulting in unstable combustion (ignition). Therefore, during the idle operation, it is preferable to use only light oil for operating the engine. In that case, the ECU 60 supplies light oil into the combustion chambers 12 by using the light-oil in-cylinder injectors 24, and does not conduct the fuel supply from the light-oil port injectors 26 or the CNG port injectors 28.

When the engine load during operation is in a light to intermediate load range, the ECU 60 supplies CNG and light oil into the combustion chambers 12 by using the CNG port injectors 28 and the light-oil port injectors 26. During this time, the ECU 60 does not conduct the fuel supply from the light-oil in-cylinder injectors 24. By supplying light oil via the intake ports 42, a pre-mixture that contains CNG, light oil and air is homogeneously formed, so that the light oil that serves as an ignition source is homogeneously dispersed. Therefore, multi-point ignition becomes more likely to occur at the time of compression, so that the combustion efficiency improves. Besides, it is possible to perform the HCCI (homogeneous charge compression ignition) combustion, which is difficult to bring about at the time of high-load operation.

As shown in FIG. 2, in this embodiment, CNG fuel is injected so as to collide with the light oil supplied via the upstream portion 42a of the intake ports, in the downstream portions 42b of the intake ports 42. Therefore, the gas streams of CNG, which is a gas fuel, accelerate the atomization of light oil, which is a liquid fuel. Thus, the homogeneity of the pre-mixture improves, so that the combustion efficiency can be further improved.

When the engine load during operation is in an intermediate to high load range, the ECU 60 supplies CNG and light oil into the combustion chambers 12 by using the CNG port injectors 28 and the light-oil in-cylinder injectors 24. During this time, the ECU 60 does not conduct the fuel supply from the light-oil port injectors 26. By supplying light oil directly into the combustion chambers 12, the pre-mixture is stratified (concentrated into specific regions) within the combustion chambers 12. Due to this, the combustion efficiency can be improved by controlling the ignition timing to a vicinity of the TDC (top dead center) and retarding the ignition timing in comparison with the ignition timing during the light to intermediate load condition.

In the case where both CNG and light oil are used as fuels, the switching between an operation mode in which the light-oil port injectors 26 are used and an operation mode in which the light-oil in-cylinder injectors 24 are used can be carried out on the basis of the engine load as described above. The former operation mode is selected in the case where the engine load is smaller than a predetermined threshold value (i.e., is in the light to intermediate load range), and the latter operation mode is selected in the case where the engine load is larger than the predetermined value (i.e., is in the intermediate to high load range). The aforementioned threshold value can be appropriately set according to the operation condition of the engine (e.g., can be prescribed by using a map as shown in FIG. 3).

Incidentally, if the amount of CNG is insufficient for the multi-fuel combustion (if the fuel has run out), the ECU 60 operates the engine only on light oil by using the light-oil in-cylinder injectors 24, as during the idle operation.

Thus, according to the internal combustion engine 100 in accordance with the first embodiment, the ECU 60 performs the switch control of the fuel injection via the light-oil in-cylinder injectors 24, the light-oil port injectors 26 and the CNG port injectors 28 (operation mode switching), so that efficient operation of the engine can be conducted in a broader operation region than in the related art.

Although in the first embodiment, the light-oil port injectors 26 and the CNG port injectors 28 are provided in the upstream portion 42a of the intake ports, these injectors may be provided at arbitrary locations in the intake system of the internal combustion engine 100.

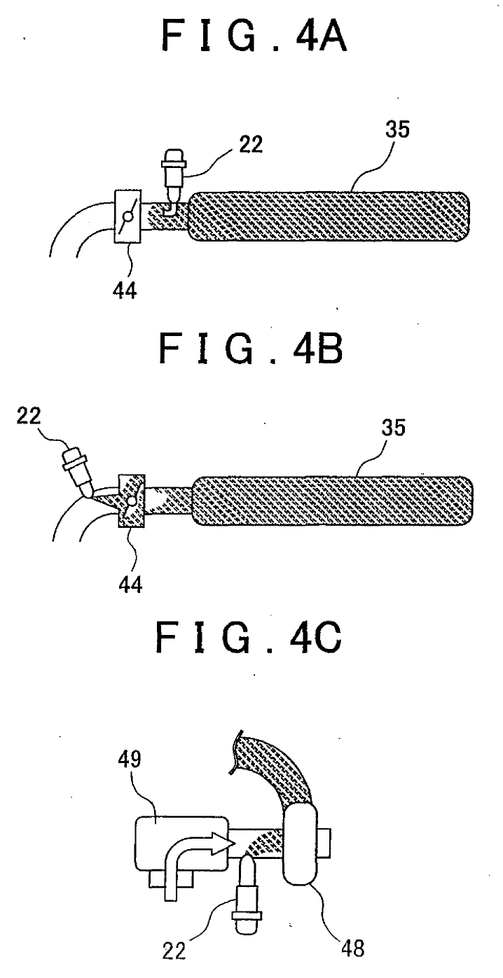

FIGS. 4A to 4C are diagrams showing modifications in which the location at which the injectors are installed is changed. In conjunction with FIGS. 4A to 4C, it is assumed that an injector 22 shown in the diagrams represents a light-oil port injector 26 or a CNG port injector 28. In FIG. 4A, the injector 22 is provided downstream of the throttle valve 44. In FIG. 4B, the injector 22 is provided upstream of the throttle valve 44. In FIG. 4C, the injector 22 is provided at an upstream side of the compressor of the turbocharger 48. The installation location of the injector 22 is shifted more to the upstream side in the order of FIG. 4A, FIG. 413 and FIG. 4C.

As the installation location of the injector 22 is shifted more to the upstream side, the mixing of air and fuel is more accelerated, and the pre-mixture becomes more homogeneous, so that the combustion efficiency accordingly improves. However, the response to changes in the fuel injection timing or in the amount of fuel injection declines if the installation location of the injector 22 is shifted to the upstream side. It is preferable that the installation location of the injectors 22 in the intake system of the internal combustion engine 100 be appropriately determined by taking the balances as mentioned above into account.

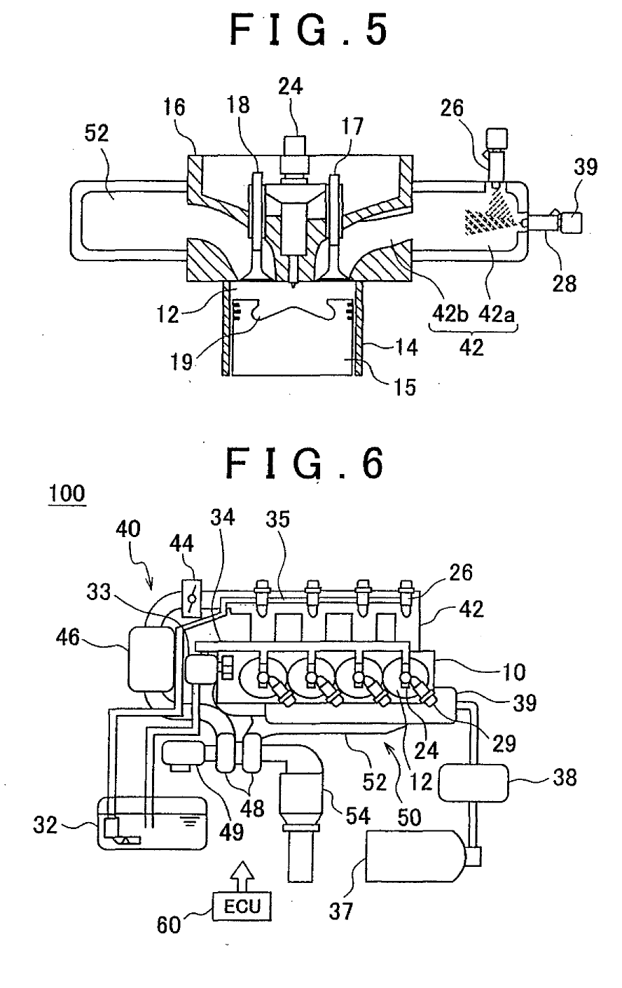

FIG. 5 is a diagram (Illustration 2 of 2) showing a modification in which the installation location of the injectors is changed. In this modification, while the light-oil port injectors 26 and the CNG port injectors 28 are both provided in the upstream portion 42a of the intake ports as in the first embodiment, the metal pipes 27 are not connected to the CNG port injectors 28, unlike the first embodiment. Besides, the injection openings of the light-oil port injectors 26 and the CNG port injectors 28 are positioned so that the CNG fuel injected from the CNG port injectors 28 collide at an intersecting angle with the light-oil fuel injected from the light-oil port injectors 26. According to this construction, due to the collision of CNG; which is a gas fuel, with light oil, which is a liquid fuel, the atomization of the light oil is accelerated and the homogeneity of the pre-mixture is increased, so that the combustion efficiency can be improved.

A second embodiment of the invention is an example in which injectors for supplying CNG are provided in combustion chambers.

FIG. 6 is a diagram showing an overall construction of an internal combustion engine according to the second embodiment. Each combustion chamber 12 is provided with a light-oil in-cylinder injector 24 and a CNG in-cylinder injector 29. The CNG in-cylinder injectors 29 are supplied with CNG fuel from a CNG fuel tank 37 via a CNG regulator 38. Other constructions of the second embodiment are substantially the same as those of the first embodiment (FIG. 1), and detailed descriptions thereof are omitted.

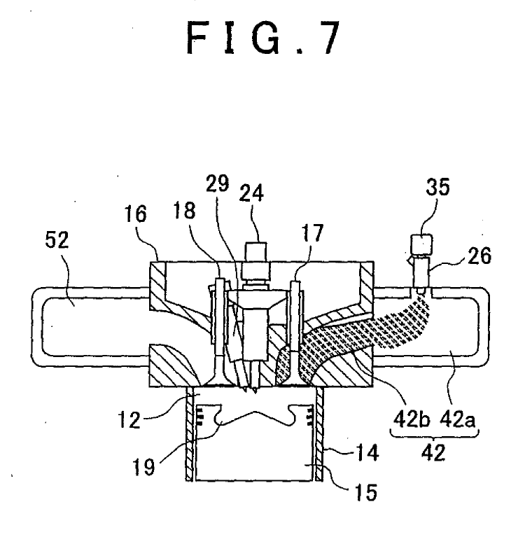

FIG. 7 is a diagram showing details of the construction of the internal combustion engine in accordance with the second embodiment. The light-oil in-cylinder injectors 24 and the CNG in-cylinder injectors 29 are provided over the combustion chambers 12. In each combustion chamber 12, the injection openings of two injectors are adjacent to each other in such an arrangement that CNG and light oil are injected from a ceiling of the combustion chamber 12 toward a cavity 19 that is formed on a piston 15. No intake port 42 is provided with a CNG injector. Other constructions of the second embodiment are substantially the same as those of the first embodiment (FIG. 2), and detailed descriptions thereof are omitted.

In the second embodiment, as in the first embodiment, the ECU 60 performs the fuel injection switch control according to the operation condition of the engine. Specifically, during the idle operation and during shortage of CNG fuel, only light oil is supplied via the light-oil in-cylinder injectors 24. During the light to intermediate engine load condition, light oil and CNG are supplied via the light-oil port injectors 26 and the CNG in-cylinder injectors 29. During the intermediate to high engine load condition, light oil and CNG are supplied via the light-oil in-cylinder injectors 24 and the CNG in-cylinder injectors 29. Therefore, efficient operation of the engine can be performed in a broader operation region than in the related art.

Although the first and second embodiments use CNG as a first fuel and light oil as a second fuel, a fuel other than these two fuels may also be used in the invention. The first fuel is a fuel that is used as a main fuel. The second fuel is a fuel that serves as a kindler for burning the first fuel, and that is capable of compression ignition. It is preferable that the second fuel be higher in compression ignition property (higher in certain number) than the first fuel.

The first embodiment uses the CNG port injectors 28 as a first fuel supply portion that supplies CNG as the first fuel, and the second embodiment use the CNG in-cylinder injector 29 as the same first fuel supply portion. Besides, in the first and second embodiments, the light-oil in-cylinder injectors 24 and the light-oil port injectors 26 are used as a second fuel supply portion and a third fuel supply portion, respectively, that supply light oil as the second fuel. It suffices that the first fuel supply portion is provided in the combustion chamber 12 or in the intake passageway 40 that communicates with the combustion chamber 12. Besides, it suffices that the second fuel supply portion is provided in the combustion chamber 12 and that the third fuel supply portion is provided in the intake passageway.

In the case where the first fuel supply portion is provided in the intake passageway 40 as in the first embodiment, it becomes easier to accelerate the mixing of the first fuel, the second fuel and air and therefore form a homogeneous air/fuel mixture. Besides, as shown in FIG. 2 and FIG. 5, the first fuel can be caused to collide with the second fuel so as to accelerate the atomization of the second fuel. As a result, the combustion can be accelerated, and the production of harmful substances, such as HC, CO, etc., can be reduced. In the meantime, in the case where the first fuel supply portion is provided in the combustion chamber 12 as in the second embodiment, it becomes easy to stratify the first fuel in the combustion chamber 12 without dispersing the fuel. As a result, the amount of the first fuel that flames out at the bore side in the combustion chamber 12 can be reduced, so that the amount of unburned HC and the like can be reduced. It is preferable to appropriately determine whether the first fuel supply portion is to be provided in the combustion chamber 12 or the intake passageway 40, by taking the advantages of the two arrangements into account.

While the invention has been described in detail with reference to what are considered to be preferred embodiments, the invention is not limited by any one of those specific embodiments, but can be modified or changed in various manners without departing from the gist of the invention described in the appended claims for patent.

1.-8. (canceled)

9. An internal combustion engine comprising:
a first fuel supply portion which is provided in an intake passageway that communicates with a combustion chamber, and which supplies a first fuel;
a second fuel supply portion that is provided in the combustion chamber and that supplies a second fuel that is capable of compression-ignited fuel;
a third fuel supply portion that is provided in the intake passageway and that supplies the second fuel; wherein
a supply opening of the first fuel supply portion and a supply opening of the third fuel supply portion are disposed so that the first fuel supplied from the first fuel supply portion and the second fuel supplied from the third fuel supply portion intersect and collide with each other.

10. The internal combustion engine according to claim 9, further comprising
a control portion that is configured to control the first fuel supply portion, the second fuel supply portion and the third fuel supply portion, wherein
the control portion being capable of switching between
an operation mode in which the first fuel and the second fuel are supplied into the combustion chamber by using the first fuel supply portion and one of the second fuel supply portion and the third fuel supply portion, and
an operation mode in which the second fuel is supplied into the combustion chamber by using the second fuel supply portion.

11. The internal combustion engine according to claim 10, wherein
during an idle operation, the control portion is configured to cause the second fuel supply portion to supply the second fuel into the combustion chamber.

12. The internal combustion engine according to claim 10, wherein
when load during operation is smaller than a threshold value determined based on an operation condition and the operation presently occurring is not an idle operation, the control portion is configured to cause the first fuel supply portion and the third fuel supply portion to supply the first fuel and the second fuel into the combustion chamber.

13. The internal combustion engine according to claim 10, wherein
when load during operation is larger than a threshold value determined based on an operation condition, the control portion is configured to cause the first fuel supply portion and the second fuel supply portion to supply the first fuel and the second fuel into the combustion chamber.

14. The internal combustion engine according to claim 9, wherein
the first fuel is natural gas, and the second fuel is light oil.
